(19) United States
(12) Patent Application Publication
(10) Pub. No.: US 2008/0166317 A1
(43) Pub. Date: Jul. 10, 2008

(54) Modified Polyamines

(76) Inventors: Harald Keller, Ludwigshafen (DE); James Bullock, Grantham (GB); Norbert Heidinger, Hassloch (DE)

Correspondence Address: CONNOLLY BOVE LODGE & HUTZ, LLP, P O BOX 2207, WILMINGTON, DE, 19899, US

(21) Appl. No.: 11/914,300

(22) PCT Filed: May 9, 2006
(86) PCT No.: PCT/EP06/62143

§ 371 Date: Nov. 13, 2007

(30) Foreign Application Priority Data
May 13, 2005 (DE) 10 2005 023 107.1

(51) Int. Cl. A01N 33/02; C08G 77/00; A01P 1/00

(52) U.S. Cl. 424/78.17; 525/474

(57) ABSTRACT

Silane-modified polymeric amines having a weight average molecular weight of 10,000 to 1,000,000 g/mol, and comprising at least one structural unit of the formula (I) which unit may comprise part of the main polymer chain or may be bound to the main polymer chain by an anchor group:

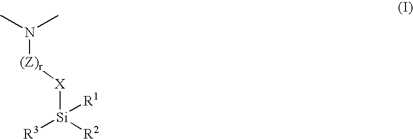

wherein X represents a bond or a —(CR⁴R⁵)ₙ— group; Z represents a —CONH—, —(CH₂)ₘ—O—, or —(CH₂)ₒ—CH(OH)—(CH₂)ₚ—(O)_{q}— group; m represents a number 1 to 6; o represents a number 0 to 6; p represents a number 1 to 6; q represents a number 0 or 1; r represents a number 0 or 1; R¹, R², and R³ each independently represent an alkyl, an OH, or an O-alkyls; R⁴ and R⁵ each independently represents an H or an alkyl; and n represents a number 1 to 20; methods for their preparation, biocidal formulations containing the same and uses therefore.

The present invention relates to polymeric amines which are chemically modified by covalent binding of silanes, a method for their production, the use of the silane-modified polymeric amines as biocides, biocidally active formulations comprising at least one inventive silane-modified polymeric amine, primers comprising at least one inventive silane-modified polymeric amine, and films comprising at least one inventive silane-modified polymeric amine.

Chemically modified polymeric amines have a variety of possible uses.

For instance, WO 99/12420 relates to the use of polymers which comprise hydroxyl-substituted N-vinylcarboxamide units as biocides.

WO 99/12424 discloses the use of carbamate-unit-comprising polymers as obtained by reacting polyethyleneimines or polymers which comprise vinylamine units with haloformic esters as biocides.

WO 2004/087226 discloses an antimicrobial substrate, a quaternary ammonium salt of an organosilicon compound, for example 3-(trimethoxysilyl)propyldimethyl-octadecylammonium chloride, adhering to at least a part of the surface of the substrate, and in addition a cationic, preferably hydrophilic, polymer, for example polyethyleneimine or polyhexamethylene biguanide hydrochloride, adhering to at least a part of the surface.

WO 86/07072 discloses special silane-modified polymers, in particular polymers which are obtained by reacting polymers having a terminal amine with a carboxyalkylalkoxysilane. According to WO 86/07072, the special silane-modified polymers are usable as compositions for paper sizing and as textile coatings, stabilizers for silicate solutions, flotation agents, treatment agents for fillers for paper and plastics, hydrophilic coatings of glass, plastics and minerals, aids for pigment dispersions, anti-corrosion agents for metal surfaces and adhesion promoters of metal primers and metal paints.

It is an object of the present application to provide novel polymeric amines which have biocidal properties and form films, which have an outstanding adhesion to surfaces and are essentially tack-free.

This object is achieved by silane-modified polymeric amines comprising at least one structural unit of the formula I

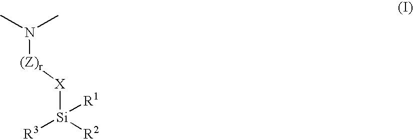

with this structural unit being able to be a part of a main polymer chain, or can be bound to a main polymer chain by an anchor group,
where:
X is a bond or a group —(CR⁴R⁵)ₙ—;
Z is —CONH—, —(CH₂)ₘ—O—, —(CH₂)ₒ—CH(OH)—(CH₂)ₚ—(O)_{q}—;
m is 1 to 6;
o is 0 to 6;
p is 1 to 6;
q is 0 or 1;
r is 0 or 1;
R¹, R², R³ independently of one another are alkyl, OH or O-alkyl;
R⁴, R⁵ independently of one another are H, alkyl;
n is 1 to 20

The inventive silane-modified polymeric amines are suitable as biocides, alone or in mixtures with other components, and exhibit, in addition, further desirable properties, such as improved adhesion of the inventive silane-modified polymeric amines to surfaces, and the formation of films, which are essentially tack-free after application to surfaces.

A main polymer chain, in the meaning of the present application, is to be taken to mean the longest chain forming the polymer. This chain is made up of carbon atoms arranged in series to one another by covalent bonds, but this carbon chain can be interrupted by heteroatoms, in particular nitrogen, silicon or oxygen. In addition, this chain can have branches which are likewise made up of carbon atoms and also if appropriate nitrogen or oxygen atoms.

An anchor group is to be taken to mean a group which links the structural unit of formula I to the main polymer chain. Such anchor groups can be alkylene groups having 1 to 14 carbon atoms which can be interrupted by heteroatoms, in particular nitrogen or oxygen. These anchor groups can be bound to carbon atoms or to heteroatoms in the main polymer chain. An anchor group is also to be taken to mean a direct bond between the structural unit of formula I and the main polymer chain. Preferred anchor groups are alkylene groups having 1 to 6, preferably 2 or 3, carbon atoms, or a bond.

In the structural unit of the formula I, X:

is a bond or a group —(CR⁴R⁵)ₙ—, preferably a group —(CR⁴R⁵)ₙ—; where
R⁴, R⁵ independently of one another are H, alkyl, preferably H; and
n is 1 to 20, preferably 1 to 6, particularly preferably 1 to 3, very particularly preferably 3.
   Z in formula I is:
   —CONH—, —(CH₂)ₘ—O—, —(CH₂)ₒ—CH(OH)—(CH₂)ₚ—(O)_{q}—, preferably —CONH—, —CH₂C(OH)CH₂O— or —C(OH)CH₂—, particularly preferably —CH₂C(OH)CH₂O— or —C(OH)CH₂—;
   where:
   m is 1 to 6, preferably 1;
   o is 0 to 6, 0 or 1;
   p is 1 to 6, 1;
   q is 0 or 1 and
   r is 0 or 1, preferably 0.

When r is 0, this means that the group Z in formula I is not present.

R¹, R² and R³ in the structural unit of formula I are:

independently of one another alkyl, O-alkyl, OH, preferably OH or O-alkyl, particularly preferably OH or OC₁₋₆-alkyl.

Preferred inventive silane-modified polymeric amines thus have at least one structural unit of the formula I, where:
X is —(CH₂)ₙ—;
n is 1 to 6, preferably 1 to 3, particularly preferably 1 or 3;
z is —CH₂C(OH)CH₂O— or —C(OH)CH₂—;
r is 0 or 1, preferably 0;
R¹, R², R³ independently of one another are OH or OC₁₋₆-alkyl, preferably OCH₃ or OC₂H₅.

In the meaning of the present application, for “alkyl”, the following definitions apply, provided that no other statements are made:

Straight-chain or branched, saturated carbon chains having 1 to 20 carbon atoms, for example alkyl radicals having 1 to 12 carbon atoms, preferably alkyl radicals having 1 to 6 carbon atoms such as methyl, ethyl, n-propyl, isopropyl, n-butyl, sec-butyl, isobutyl, t-butyl, n-pentyl, sec-pentyl, isopentyl, n-hexyl, 1-, 2- or 3-methylpentyl; in addition, the alkyl radicals of longer-chain radicals such as unbranched heptyl, octyl, nonyl, decyl, undecyl, lauryl and the singly or multiply branched analogs thereof. In addition, suitable radicals are alkyl radicals having more than 12 carbon atoms such as unbranched tridecyl, myristyl, pentadecyl, palmityl, heptadecyl, stearyl, nonadecyl and eicosyl and also the singly or multiply branched analogs thereof. Preferred alkyl radicals are the abovementioned C₁-C₆-alkyl radicals. Particular preference is given to methyl and ethyl.

The weight average molecular weight of the inventive silane-modified polymeric amines is generally >500 g/mol, preferably 1000 to 2 000 000 g/mol, particularly preferably 10 000 to 1 000 000 g/mol (determined by GPC using polystyrene standard).

Particularly preferably, the inventive silane-modified polymeric amines are polymers which comprise one or more of the repeating units of the formulae II, III and/or IV and/or one or two end groups of the formula V, and also if appropriate further units according to formula VII

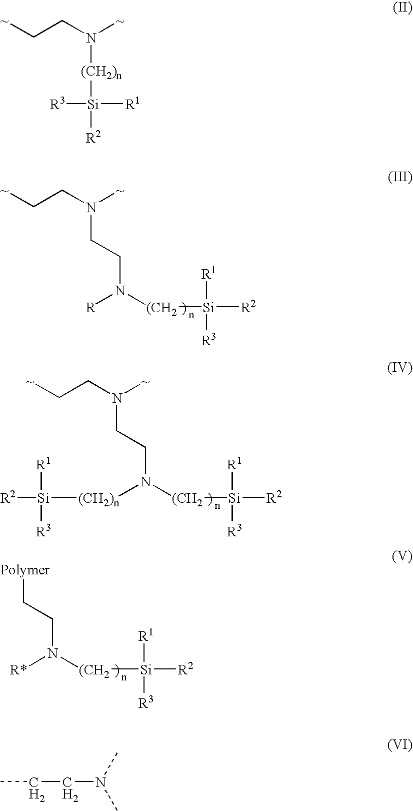

where:
R is hydrogen or an optionally substituted or unsubstituted organic radical, preferably hydrogen, alkyl or a radical based on ethyleneimine such as —(CH₂CH₂NH)ₙ—H, where n′ is the number of repeating units depending on the weight average molecular weight of the polyethyleneimine used;
R* is hydrogen or —(CH₂)ₙ—SiR¹R²R³;
n is 1 to 6;
R¹, R², R³ independently of one another are OH or O-alkyl;
polymer is any polymer which is suitable for binding to the structural unit defined in formula V.

The inventive silane-modified polymeric amines are generally obtained by reacting a polymeric amine with suitable silanes.

Suitable polymeric amines are polymers comprising amino groups, with the amino groups being able to be primary, secondary or tertiary. Polymers, in the meaning of the present application, are to be taken to mean not only polymers but also oligomers.

Preferably, the polymeric amines which are reacted with suitable silanes are selected from the group consisting of polyalkylenepolyamines, vinylamine unit-comprising polymers, amine-epichlorohydrin polycondensates, polyaddition products of multifunctional epoxides and multifunctional amines, polyallylamines, condensates of lysine, condensates of ornithine and condensates of arginine. Preferably, polymeric amines are selected from polyalkylenepolyamines, vinylamine unit-comprising polymers and condensates of lysine. Particular preference is given to polyalkylenepolyamines.

Suitable polyalkylenepolyamines are compounds which have at least three basic nitrogen atoms, such as diethylenetriamine, dipropylenetriamine, triethylenetetramine, tripropylenetetramine, tetraethylenepentamine, pentaethylenehexamine, hexaethylene-heptamine and polyethylenediamines. Preferred polyalkylenepolyamines have a weight average molecular weight of generally >500 g/mol, preferably 1000 to 2 000 000, particularly preferably 10 000 to 1 000 000 g/mol (determined by GPC using polystyrene standard).

Preferred polyalkylenepolyamines are polyalkyleneimines, preferably polyethyleneimines. Suitable polyalkyleneimines are available by conventional methods known to those skilled in the art and are marketed commercially. Suitable polyalkyleneimines are all polymers which are obtainable by cationically initiated polymerization of ethyleneimine (aziridine) and/or N-substituted aziridines. In addition, polyethyleneimines are to be taken to mean the polymers of higher homologs of ethyleneimine and also graft polymers of polyamidoamines or polyvinylamines with ethyleneimine or its higher homologs, and also polyamidoamines. The polyalkyleneimines can be non-crosslinked or crosslinked, quaternized and/or modified by reacting with alkylene oxides, dialkyl or alkylene carbonates or C₁- to C₄-carboxylic acids.

Preferred polyalkyleneimines are homopolymers of ethyleneimine (aziridine). These can be in non-crosslinked or crosslinked form. The polyethyleneimine homopolymers can be produced by known methods, as described for example in Römpps Chemielexikon [Römpp's Chemistry Lexicon], 8th edition, 1992, pp. 3532 to 3533, or in Ullmanns Enzyklopädie der technischen Chemie [Ullmann's Encyclopedia of Industrial Chemistry], 4th edition, 1974, volume 8, pp. 212 to 213 and the literature cited there. They generally have molecular weights (weight average) in the range >500 g/mol, preferably 1000 to 2 000 000 g/mol, particularly preferably 1 0000 to 1 000 000 g/mol (determined by GPC using polystyrene standard). In this case, higher-molecular-weight polymers are obtained by crosslinking with polyfunctional compounds.

Suitable polyfunctional crosslinking compounds are, for example, diisocyanates, such as hexamethylene diisocyanate, isophorone diisocyanate, dicyclohexylmethane 4,4′-diisocyanate and diphenylmethane diisocyanate, dihaloalkanes such as 1,2-dichloroethane, 1,3-dichloropropane, 1,4-dichlorobutane and 1,6-dichlorohexane, diepoxides such as oligo- and polyethylene glycol bisepoxides, epihalohydrines such as epichlorohydrin, bischlorohydrinethers of alkylene glycols and polyalkene glycols having 2 to 100 ethylene oxide and/or propylene oxide units, alkylene carbonates such as ethylene carbonate and propylene carbonate and bischloroformates such as 2,2-dimethylpropylene bischloroformate.

Further suitable polyalkyleneimines are graft polymers of polyamidoamines with ethyleneimine. These can be crosslinked using the abovementioned crosslinkers.

Grafted polyamidoamines are known, for example, from U.S. Pat. No. 4,144,123 or DE-A 24 34 186. Polyamidoamines are available, for example by condensation of
(i) polyalkylenepolyamines, which can be in a mixture with diamines, with
(ii) at least dibasic carboxylic acids such as oxalic acid, malonic acid, succinic acid, maleic acid, fumaric acid, itaconic acid, adipic acid, tartaric acid, citric acid, propanetricarboxylic acid, butanetetracarboxylic acid, glutaric acid, suberic acid, sebacic acid, terephthalic acid, and also its esters, acid chlorides or anhydrides, which can be in a mixture with up to 50 mol % monobasic amino acids, monobasic hydroxycarboxylic acids and/or monobasic carboxylic acids,
   in a molar ratio of (i) to (ii) of 1 to 0.5 to 1 to 2.

Polyalkylenepolyamines I suitable for the condensation are compounds which comprise at least three basic nitrogen atoms in the molecule, for example diethylenetriamine, dipropylenetriamine, triethylenetetramine, tripropylenetetramine, tetraethylenepentamine, pentaethylenehexamine, N-(2-aminoethyl)-1,3-propanediamine and N,N′-bis(3-aminopropyl)ethylenediamine.

Suitable diamines are, for example, 1,2-diaminoethane, 1,3-diaminopropane, 1,4-diaminobutane, 1,6-diaminohexane, 1,8-diaminooctane, isophoronediamine, 4,4′-diaminodiphenylmethane, 1,4-bis(3-aminopropylpiperazine), 4,9-dioxadodecane-1,12-diamine, 4,7,10-trioxamidecane-1,13-diamine or a,z-diamino compounds of polyalkylene oxides.

Condensation of the compounds II proceeds, for example, as disclosed in EP-0 703 972.

The abovementioned graft polymers generally comprise 10 to 90% by weight polyamidoamines as graft substrate and 90 to 10% by weight ethyleneimine as graft superstrate.

Polyalkyleneimines in the meaning of the present application are also polymers comprising such ethyleneimine units which are obtainable by grafting polyvinylamines with ethyleneimine. Polyvinylamines are obtainable by complete or partial saponification of polymers of open-chain N-vinylcarboxamides of the general formula VII

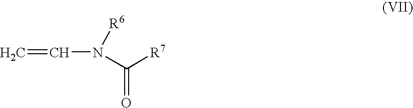

where R⁶ and R⁷ independently of one another are hydrogen or C₁- to C₆-alkyl. Suitable polyvinylamines are described in more detail hereinafter. The degree of saponification is generally 5 to 100%. The graft polymers can be crosslinked using the abovementioned crosslinkers.

The graft polymers generally comprise 10 to 90% by weight polyvinylamines as graft substrate and 90 to 10% by weight ethyleneimine as graft superstrate.

Polyalkyleneimines in the meaning of the present application are in addition to be taken to mean, in addition to the abovementioned homopolymers of ethyleneimine, graft polymers of polyamidoamines and ethyleneimine and graft polymers of polyvinylamines with ethyleneimine, the corresponding polymers of higher homologs of ethyleneimine such as propyleneimine (2-methylaceridine), 1- or 2-butyleneimine (2-ethylaceridine or 2,3-dimethylaceridine). However, preference is given to the polymers of ethyleneimine.

The abovementioned polyalkyleneimines can be modified by reacting with alkylene oxides such as ethylene oxide, propylene oxide or butylene oxide, dialkyl carbonates such as dimethylcarbonate and diethylcarbonate, alkylene carbonates such as ethylene carbonate or propylene carbonate, or C₁-C₄-carboxylic acid.

In addition, the abovementioned polyalkyleneimines can also be in quaternized form. Suitable quaternizing agents are alkylating agents such as dimethyl sulfate, diethyl sulfate, methyl chloride, methyl iodide, ethyl chloride or benzyl chloride. The degree of alkylation of the polyalkyleneimines is generally 1 to 50%, preferably 1 to 10%. Degree of alkylation is taken to mean the percentage fraction of the alkylated monomer units in the polymer, based on the total number of monomer units in the polyalkyleneimine.

In addition, the abovementioned polyalkyleneimines can be modified by sulfonation or phosphonomethylation, sulfonated or phosphonomethylated polyalkyleneimines being obtained, respectively.

In addition to said polyalkyleneimines, polyamidoamines can be used as polymeric amines according to the present application. These can be obtained, for example, by condensing dicarboxylic acids with polyamines. Suitable polyamidoamines are, for example, obtainable by reacting dicarboxylic acids having 4 to 10 carbon atoms with polyalkylenepolyamines which comprise 3 to 10 basic nitrogen atoms in the molecule. Suitable dicarboxylic acids are, for example, succinic acid, maleic acid, adipic acid, glutaric acid, suberic acid, sebacic acid or terephthalic acid. In the production of the polyamidoamines, use can also be made of mixtures of dicarboxylic acids, likewise mixtures of a plurality of different polyalkylenepolyamines. Suitable polyalkylenepolyamines are, for example, diethylenetriamine, triethylenetetramine, tetraethylenepentamine, dipropylenetriamine, tripropylenetetramine, dihexamethylene-triamine, aminopropylethylenediamine and bisaminopropylethylenediamine. For production of the polyamidoamines, the dicarboxylic acids and polyalkylenepolyamines are generally heated to elevated temperatures, for example to temperatures in the range from 120 to 220° C., preferably 130 to 180° C. The water produced in the condensation is removed from the system. In the condensation, use can also be made, if appropriate, of lactones or lactams of carboxylic acids having 4 to 8 carbon atoms. Generally, per mol of a dicarboxylic acid, 0.8 to 14 mol of a polyalkyleneamine are used. The polyamidoamines can additionally if appropriate be crosslinked using the abovementioned polyfunctional crosslinking compounds.

Further suitable polymeric amines are polymers comprising vinyl units, in particular polyvinylamines. In the meaning of the present application, polyvinylamines are taken to mean the homopolymers or copolymers of N-vinylcarboxamides which are at least in part saponified. The polyvinylamines can be non-crosslinked or crosslinked, quaternized and/or modified by reacting with alkylene oxides, dialkyl or alkylene carbonates or C₁- to C₄-carboxylic acids.

Polyvinylamines in the meaning of the present application are to be taken to mean at least partly saponified N-vinylcarboxamide homopolymers. For their production, one starts, for example, from open-chain N-vinylcarboxamides of the abovementioned formula VII. Suitable monomers are, for example, N-vinylformamide (R⁶═R⁷═H in formula VII), N-vinyl-N-methylformamide (R⁶=methyl, R⁷═H in formula VII), N-vinylacetamide (R¹═H, R²=methyl in formula VII), N-vinyl-N-methylacetamide (R⁶═R⁷=methyl in formula VII) and N-vinyl-N-ethylacetamide (R⁶=ethyl, R⁷=methyl in formula VII). Preferably, N-vinylformamide is used.

In addition, polyvinylamines in the meaning of the present application are to be taken to mean at least partly saponified N-vinylcarboxamide copolymers. These are preferably made up from:
(a) 0.1 to 100 mol % N-vinylcarboxamides of the formula VII and
(b) 0 to 99.9 mol % vinyl formate, vinyl acetate, vinyl propionate, vinyl alcohol, N-vinylurea, N-vinylpyrrolidone, N-vinylpiperidone, N-vinylcaprolactam, N,N-divinylethyleneurea and/or N-vinylimidazole,
   the sum of (a) and (b) giving 100 mol % which are at least in part saponified.

Suitable N-vinylcarboxamides are the abovementioned compounds. Preference is given to N-vinylformamide.

The abovementioned polyvinylamines generally have a K value of 5 to 300 (determined in accordance with H. Fikkentscher, Zellulosechemie, volume 13, pages 58 to 64 and 71 to 74 (1932) in 5% strength by weight aqueous sodium chloride solution at 25° C. and a polymer concentration of 0.5% by weight).

The abovementioned polyvinylamines are at least in part saponified, that is the amide groups originally present in the polymers are 5 to 100%, preferably 20 to 100%, particularly preferably 40 to 100%, converted to amino groups by saponification. The saponification can proceed not only in alkaline medium, but also in acidic medium.

The inventively used polymers comprising vinylamine units (polymers also being taken to mean copolymers) are produced by methods as are disclosed, for example, by U.S. Pat. No. 4,421,602, EP-A 0 216 387 and EP-A 0 251 182.

The abovementioned polyvinylamines can also be crosslinked. Suitable crosslinkers are the crosslinkers mentioned with respect to the polyalkylenepolyamines.

The abovementioned polyvinylamines can be modified by reacting with alkylene oxides such as ethylene oxide, propylene oxide or butylene oxide, dialkyl carbonates, such as dimethylcarbonate and diethylcarbonate, alkylene carbonates such as ethylene carbonate or propylene carbonate, or C₁-C₄-carboxylic acids.

In addition, the abovementioned polyvinylamines can be in quaternized form. Suitable quaternizing agents are alkylating agents such as dimethyl sulfate, diethyl sulfate, methyl chloride, methyl iodide, ethyl chloride or benzyl chloride. The degree of alkylation of the polyvinylamines is generally 1 to 50%, preferably 10 to 50%. Degree of alkylation is taken to mean here the percentage fraction of alkylated monomer units in the polymer, based on the total number of monomer units in the polyvinylamine.

Further suitable polymeric amines are condensates of lysine (polylysines). These generally have a weight average molecular weight M_{w} of 250 to 250 000 g/mol, preferably 500 to 100 000 g/mol (determined by means of GPC using polystyrene standard). Condensates of lysine are also to be taken to mean lysine cocondensates which have molar masses of M_{w} 250 to 250 000 g/mol. Suitable cocondensable components are, for example, amines, polyamines, ketene dimers, lactams, alcohols, alkoxylated amines, alkoxylated alcohols and/or non-proteinogenic amino acids.

In addition, polyallylamines also come into consideration as polymeric amines according to the present application. Polyallylamines are generally prepared by homopolymerization of allylamine or by copolymerization of allylamine with other monoethylenically unsaturated monomers which have already been mentioned above as comonomers in the production of polyvinylamines by reacting N-vinylcarboxamides with further comonomers.

All preferably suitable polymeric amines selected from the group consisting of polyalkylenepolyamines, vinylamine unit-comprising polymers, amine-epichlorohydrin polycondensates, polyaddition products of multifunctional epoxides and multifunctional amines, polyallylamines, condensates of lysine, condensates of ornithine and condensates of arginine are polymers known to those skilled in the art and can be produced by methods known to those skilled in the art. Preferred polymeric amines are cited and described in more detail above.

Particularly preferably, the polymeric amines which are reacted to give the silane-modified polymeric amines according to the present application are selected from polyalkylenepolyamines, vinylamine unit-comprising polymers and condensates of lysine. Preferably used polyalkylenepolyamines, vinylamine unit-comprising polymers and condensates of lysine are already mentioned above. Particularly preferably, use is made of polyalkylenepolyamines, polyalkyleneimines being very particularly preferred. Further preference is given to polyethyleneimines. Embodiments of polyethyleneimines which are suitable in particular have already been mentioned above.

Very particularly preferably according to the present invention, as polymeric amines to be reacted with silanes, use is made of polyethyleneimines which have a molecular weight of generally >500 g/mol, preferably 1000 to 2 000 000 g/mol, preferably 10 000 to 1 000 000 g/mol (determined by GPC using polystyrene standard). These are in particular homopolymeric polyethyleneimines which, in addition to the modification by reaction with silanes, are not further modified.

The silane-modified polymeric amines according to the present invention are produced by reacting polymeric amines comprising at least one structural unit of the formula VIII

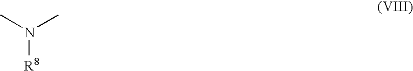

with this structural unit being able to be a part of a main polymer chain, or can be bound to a main polymer chain by an anchor group,
where R⁸ is H or alkyl,
with silanes of the formula IX

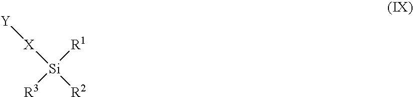

where:
X is a bond or a group —(CR⁴R⁵)ₙ—;
R¹, R², R³ independently of one another are alkyl, OH or O-alkyl;
R⁴, R⁵ independently of one another are H or alkyl;
n is 1 to 20;
Y is a group reactive with the structural unit of the formula VIII of the polymeric amine, preferably selected from the group consisting of halogen, preferably chlorine, epoxy, sulfido, isocyanato, cyano, azido and vinyl groups.

Preferred radicals or groups X, R¹, R², R³, R⁴, R⁵ and n are the corresponding groups already mentioned above.

The expressions “anchor group” and “main polymer chain” have already been explained above.

The number of structural units of the formula VIII in the polymeric amines is a function of the polymeric amines used and also of their molecular weights. Suitable polymeric amines and their molecular weights are mentioned above.

Particularly preferred polymeric amines are those which comprise one or more repeating units of the formulae X, XI and/or XII, and/or one or two end groups of the formula XIII, and also if appropriate further units according to formula XIV.

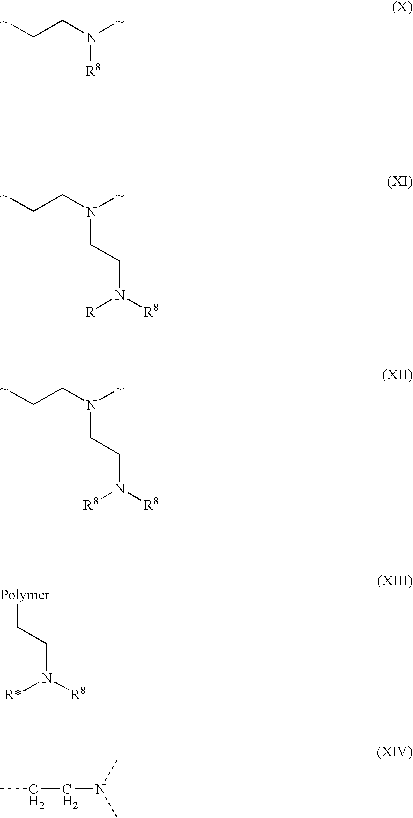

where:
R is hydrogen or an optionally substituted or unsubstituted organic radical, preferably hydrogen or a radical based on ethyleneimine, such as —(CH₂CH₂NH)ₙ—H,
R* is hydrogen or R⁸,
polymer is any polymer which is suitable for binding to the structural unit defined in formula XII,
R⁸ is hydrogen or alkyl.

Suitable polymeric amines and also preferred embodiments are mentioned above,

The silanes of formula IX can be produced by methods known to those skilled in the art or are commercially available. Preferred silanes are trialkoxysilanes, that is silanes where R¹, R² and R³ are OH or O-alkyl, particularly preferably O-alkyl. Suitable alkyl radicals are mentioned above, with methyl and ethyl being particularly preferred. Very particularly preferably, all three radicals R¹, R² and R³ have the same meaning and are either methoxy or ethoxy. The group X in the silanes of the formula IX is particularly preferably —(CH₂)ₙ—, where n is 1 to 6, very particularly preferably n is 1 to 3, and in particular preferably 1 or 3.

Particularly suitable silanes are, for example, 3-(glycidoxy)propyltriethoxysilane, 3-(glycidoxy)propyltrimethoxysilane, 3-chloropropyltriethoxysilane, 3-chloropropyltri-methoxysilane, 3-isocyanatopropyltriethoxysilane, 3-isocyanatopropyltrimethoxysilane, 3-azidopropyltriethoxysilane, 3-azidopropyltrimethoxysilane, 3-cyanopropyltriethoxy-silane or 3-cyanopropyltrimethoxysilane. Particular preference is given to 3-(glycidoxy)propyltriethoxysilane, 3-(glycidoxypropyltrimethoxysilane, 3-chloropropyl-triethoxysilane or 3-chloropropyltrimethoxysilane.

In the production of the inventive silane-modified polymeric amines, generally 10 to 80, preferably 15 to 75, particularly preferably 20 to 65, silane molecules of the formula IX are reacted with a polymeric amine molecule of the formula VIII.

Generally, in the reaction of the polymeric amines comprising at least one structural unit of the formula VIII with the silanes of the formula IX, use is made of 1 to 30% by weight, preferably 2 to 25% by weight silane, based on the polymeric amine used.

The reaction is generally carried out in a solvent.

Suitable solvents are alcohols, in particular ethanol.

The reaction period is generally 2 to 8 hours, preferably 4 to 6 hours. The reaction temperature is generally 50 to 180° C., preferably 70 to 160° C.

The reaction can be carried out at atmospheric pressure or at elevated pressure, for example 2 to 20 bar.

Further subject matter of the present application is silane-modified polymeric amines produced by the inventive method mentioned above.

The silane-modified polymeric amines according to the present invention can be used for numerous applications. They are distinguished, in particular, by biocidal properties and can therefore be used as biocides, alone or in combination with further suitable components. In addition, the inventive silane-modified polymeric amines have improved adhesion to surfaces compared with non-silane-modified polymeric amines. Films which are generated from the inventive silane-modified polyvinyls are essentially tack-free after their application to surfaces. In addition to use of the inventive silane-modified polymeric amines as biocides, the inventive silane-modified polymers can therefore, in addition, be used as primers in the production of coatings and paints, and also for antistatic finishing of materials.

Further subject matter of the present application is therefore the use of the silane-modified polymeric amines according to the present invention as biocides. The inventive silane-modified polymeric amines can therefore be used for combating unwanted microorganisms. The silane-modified polymeric amines and formulations prepared therefrom are suitable for chemically destroying, repelling, rendering harmless, harmful organisms, preventing damage due to them or combating them in another manner.

The inventive silane-modified polymeric amines differ from customary biocides which are generally low-molecular-weight compounds in that the inventive silane-modified polymeric amines, after application to an article to be treated, for example from aqueous solution, generally after drying form a covalently crosslinked insoluble polymer. This is fixed on the article to be treated and, in contrast to low-molecular-weight biocides, exhibits no tendency to diffuse in an uncontrolled manner to sites where the presence of biocides is unwanted.

The inventive silane-modified polymeric amines and their formulations prevent the microbial infection of technical materials, that is they can be used for pot condensation. They are also used for the biocidal finishing of products, that is they can be used for film preservation.

Technical materials are to be taken to mean non-living materials as occur in technical/industrial processes. Technical materials which are to be protected from microbial change or destruction by the inventive use of the inventive silane-modified polymeric amines and their formulations are, for example.

textile finishes, drilling oils, dispersions, adhesives, sizes, pigment preparations, paper, textiles, textile auxiliaries, leather, leather auxiliaries, wood, coatings, antifouling paints, plastic articles, cosmetics, laundry and dishwashing detergents, cooling lubricants, hydraulic liquids, joint sealants, window putty, thickener solutions and other materials which can be attacked or decomposed by microorganisms.

Likewise, the inventive silane-modified polymeric amines and formulations thereof can be used in water treatment. Water treatment is taken to mean addition of the inventive silane-modified polymeric amines or formulations thereof to water for manufacturing use, for example for combating slime in the paper industry or for controlling harmful organisms in the sugar industry. They prevent or control the growth of microorganisms in cooling circuits, air humidifiers, or in drilling and well liquids in the petroleum industry.

The inventive silane-modified polymeric amines and formulations thereof can, in addition, be used for disinfection, for example for disinfecting bottles, instruments, hands, refuse, water effluence and in washing. The inventive silane-modified polymeric amines and formulations thereof can be used, for example, in hospitals, care homes for the elderly or old people's homes, where disinfection of the abovementioned materials and objects plays an important role, because most patients have only low resistance to infections.

Microorganisms which can cause breakdown or change of technical materials which may be mentioned by way of example are bacteria, viruses, spores, yeasts, molds, algae and slime organisms.

The inventive silane-modified polymeric amines can, depending on their chemical and physical properties, be converted into formulations, for example emulsions, suspensions, dispersions, solutions, powders, pastes or in combination with support materials. For this, if appropriate surface-active substances, for example anionic surfactants such as alkylsulfonates, ethersulfates; nonionic surfactants such as fatty alcohol ethoxylates, fatty alcohol ester ethoxylates, sorbitan esters, polyalkylene glycols; amphoteric surfactants, complexing agents, for example ethylenediaminetetraacetic acid, nitrilotriacetic acid, methylglycinediacetic acid, solubilizers, for example alcohols such as ethanol, n-propanol, isopropanol; glycols such as propylene glycol, polypropylene glycol, acids or bases, for example phosphoric acid, sodium hydroxide solution, inorganic salts and/or other additives, for example corrosion inhibitors, antifoams, odorants, dyes, are added to the formulations. The amounts of the components present in the formulations are dependent on the silane-modified polymeric amines used, the further additives used and also on the purpose of use.

Methods for producing such biocidally active formulations are known to those skilled in the art and are described in the relevant literature.

Further subject matter of the present application is therefore a biocidally active formulation comprising at least one inventive silane-modified polymeric amine. In addition, the inventive biocidal formulation can comprise at least one further additive, suitable additives being mentioned above.

The inventive formulations can be in solid form or in liquid form, that is in emulsions, suspensions, dispersions, solutions or as powders, pastes or in combination with support materials.

The activity and spectrum of activity of the inventive silane-modified polymeric amines and the formulations produced therefrom can be increased when, if appropriate, further biocidally active compounds such as fungicides, bactericides and/or herbicides, insecticides and/or other active ingredients are added to broaden the spectrum of activity or to achieve special effects. In many cases this produces synergistic effects, that is the spectrum of activity of the mixture exceeds the activity of the individual components. Such substances are known to those skilled in the art and are described in the literature.

Suitable biocidally active compounds are, for example, alcohols, halogenated alcohols likewise being encompassed, isothiazolones, activated halogen compounds, formaldehyde-releasing compounds, phenolic compounds, aldehydes, acids and esters, biphenyls, urea derivatives, O-acetals, N-acetals, benzamidines, phthalimides, pyridine derivatives, quaternary ammonium and phosphonium compounds, amines, amphoteric compounds, dithiocarbamates, compounds which comprise active oxygen such as peroxides, and inorganic salts such as metal oxides.

These compounds can be present either alone or in the form of mixtures of at least two of these compounds in the inventive formulations comprising at least one silane-modified amine.

The inventive silane-modified polymeric amines can be in the form of concentrates which are either water-based or based on an organic solvent, and if appropriate comprise one or more of the abovementioned additives and/or one or more of the abovementioned biocidally active compounds. Preferred formulations are based on water and can if appropriate comprise small amounts of organic solvents. Preferably, the formulations comprise no organic solvent.

The concentrates according to the present invention can comprise between 5 and 60% by weight, preferably between 10 and 45% by weight, particularly preferably between 20 and 40% by weight, very particularly preferably between 20 and 30% by weight, based on the total amount of the concentrate, of the inventive silane-modified polymeric amine.

The formulations intended for use comprise smaller amounts of the at least one inventive silane-modified polymeric amine, the concentration in the formulations intended for use generally being 0.001 to 10% by weight, preferably 0.01 to 5% by weight, particularly preferably 0.02 to 1.5% by weight, based on the total weight of the formulation intended for use (comprising the liquid components to be treated). These formulations suitable for use can comprise the additives already mentioned with respect to the concentrates, and further biocidally active compounds.

Preferably, the ready- to-use formulations are aqueous, in which case small amounts of volatile organic solvents may be present. Preferably, no volatile organic solvents are present.

Suitable organic solvents are, in particular, water-miscible solvents such as alcohols, for example methanol, ethanol, 1-propanol or 2-propanol. The amount of water should generally be at least 50% by weight, preferably at least 70% by weight, of the total amount of all solvents. As already mentioned above, the inventive formulations preferably comprise no organic solvent.

The pH of the inventive formulations can vary from, for example, 2 to 12, like that of the medium to be treated. Concentrated alkaline formulations are particularly effective against microorganisms. Therefore, it is preferred that the inventive formulations have a pH of at least 4, preferably at least 7, particularly preferably at least 8. The pH can be adjusted, for example, by means of potassium hydroxide.

Further subject matter of the present application is thus biocidally active formulations comprising

a) at least one inventive silane-modified polymeric amine,
b) at least one further biocidally active compound,
c) if appropriate at least one additive,
d) if appropriate water and/or at least one organic solvent.

Suitable and preferred silane-modified polymeric amines, biocidally active compounds, additives and solvents and also suitable concentrations of the silane-modified polymeric amines are already mentioned above. The amounts of the further components depend on the purpose of use.

In addition to their biocidal activity, the inventive silane-modified polymeric amines are, in addition, distinguished by having better adhesion to surfaces than non-silane-modified polymeric amines.

Suitable surfaces in this case are any surfaces, in particular solid surfaces such as metal or plastic surfaces, or else surfaces of wood, glass, porcelain and also flexible surfaces, for example films such as polyester films, polyethylene, polypropylene, polyamide, polycarbonate and polyvinyl chloride films, textiles, e.g. made of natural fibers such as cotton, or artificial fibers such as polyester or mixed fabrics of natural and artificial fibers, leather and paper. The inventive silane-modified polymeric amines can therefore be used as or in primer(s).

Further subject matter of the present application is therefore a primer comprising at least one silane-modified polymeric amine according to the present invention. Suitable further additives and ingredients in primers and also the production of primers are known to those skilled in the art.

A further property of the inventive silane-modified polymeric amines is the production of tack-free films after application to surfaces. Suitable surfaces are the surfaces already mentioned above.

Further subject matter of the present application is therefore films comprising at least one silane-modified polymeric amine according to the present invention.

These films are films applied to surfaces selected from the surfaces mentioned above. The films are applied, for example, by dissolving the at least one inventive silane-modified polymeric amine in a solvent, preferably in water, a solution being obtained in which the inventive silane-modified polymeric amine is present at a content of 0.1 to 40% by weight, preferably 0.5 to 25% by weight, particularly preferably 5 to 15% by weight. The resultant solution can be applied to a surface, for example, using a coating blade. In addition, application is possible, e.g. by immersion, spraying, spin-coating, rolling. Subsequently the resultant moist film is dried, the drying time being dependent on the solvent used and also on the drying temperature. Further methods for producing films comprising at least one inventive silane-modified polymeric amine are known to those skilled in the art.

A particular advantage of the inventive silane-modified polymeric amines is that their aqueous solutions are permanently stable and do not have a tendency to flocculation or gelation, like aqueous solutions of compounds functionalized by silane groups which are known from the prior art. The aqueous solutions of the inventive silane-modified polymeric amines are therefore storage-stable and can be marketed in the form of ready- to-use aqueous formulations or aqueous concentrates. Further subject matter of the present application is therefore formulations comprising the inventive silane-modified polymeric amines and water. If appropriate, the formulations can comprise further components, e.g. additives, further biocidal compounds, or solvents. Suitable additives, further biocidal compounds and solvents are already mentioned above.

The inventive films are distinguished in that they are essentially tack-free and adhere outstandingly well to the surfaces to which they are applied. In addition, the inventive films are distinguished by outstanding antistatic properties.

The examples hereinafter additionally describe the invention.

### EXAMPLES

### Synthesis

### Example 1

In an autoclave, 80 g of polyethyleneimine (Mw=25 000 g/mol) are dissolved in 300 g of absolute ethanol. The autoclave is purged with dry nitrogen and closed. Then, with stirring, the internal temperature is increased to 150° C. The internal pressure rises in the course of this to approximately 1.013 10⁶ Pa. As soon as the internal temperature of 150° C. is reached, 20 g of 3-chloropropyltrimethoxysilane are added dropwise in the course of 30 min. Subsequently, the mixture is stirred for a further 4 h at 150° C. Thereafter, the reaction batch is cooled slowly in the autoclave. A light-yellowish solution having a solids content of 25% is obtained.

### Example 2

In an autoclave, 90 g of polyethyleneimine (Mw=25 000 g/mol) are dissolved in 300 g of absolute ethanol. The autoclave is purged with dry nitrogen and closed. Then, with stirring, the internal temperature is increased to 150° C. The internal pressure rises in the course of this to approximately 1.013 10⁶ Pa. As soon as the internal temperature of 150° C. is reached, 10 g of 3-chloropropyltrimethoxysilane are added dropwise in the course of 30 min. Subsequently, the mixture is stirred for a further 4 h at 150° C. Thereafter, the reaction batch is cooled slowly in the autoclave. A light-yellowish solution having a solids content of 25% is obtained.

### Example 3

In an autoclave, 98 g of polyethyleneimine (Mw=750 000 g/mol) are dissolved in 282 g of absolute ethanol. The autoclave is purged with dry nitrogen and closed. Then, with stirring, the internal temperature is increased to 150° C. The internal pressure rises in the course of this to approximately 1.013 10⁶ Pa. As soon as the internal temperature of 150° C. is reached, a solution of 2 g of 3-chloropropyltrimethoxysilane in 18 g of ethanol is added dropwise in the course of 30 min. Subsequently, the mixture is stirred for a further 4 h at 150° C. Thereafter, the reaction batch is cooled slowly in the autoclave. A light-yellowish solution having a solids content of 25% is obtained.

### Example 4

In an autoclave, 98 g of polyethyleneimine (Mw=25 000 g/mol) are dissolved in 282 g of absolute ethanol. The autoclave is purged with dry nitrogen and closed. Then, with stirring, the internal temperature is increased to 150° C. The internal pressure rises in the course of this to approximately 1.013 10⁶ Pa. As soon as the internal temperature of 150° C. is reached, a solution of 2 g of 3-(glycidoxy)propyltriethoxysilane in 18 g of ethanol is added dropwise in the course of 30 min. Subsequently, the mixture is stirred for a further 4 h at 150° C. Thereafter, the reaction batch is cooled slowly in the autoclave. A light-yellowish solution having a solids content of 25% is obtained.

### Example 5

### Stability of the Aqueous Solutions

The products of Examples 1 to 4 were each diluted to a solids content of 10% and 1% by demineralized water. Even at high water contents, excellent storage stabilities were observed. In all cases, even after storage of 100 days at 20° C., no change in the solutions was observed.

### Production of Layers/Films

### Example 6

### Comparative Example

Polyethyleneimine (Mw=25 000 g/mol) is diluted to a solids content of 10% by demineralized water. Using a coating blade (coating gap 50 μm), the solution is spread onto a polyester film. After 17 h of drying time at 20° C., a clear thin layer is obtained on the film. The layer is very tacky.

The coated film is immersed for 2 h in demineralized water and subsequently examined optically. The layer is no longer detectable. It has completely dissolved in the water.

### Example 1.1

The product of Example 1 is diluted to a solids content of 10% by demineralized water. Using a coating blade (coating gap 50 μm), the solution is spread onto a polyester film. After 17 h of drying time at 20° C., a clear thin layer is obtained on the film which is no longer tacky. By increasing the temperature, the drying time can be significantly shortened.

The coated film is immersed for 2 h in demineralized water and subsequently examined optically. The layer has excellent adhesion even after the treatment with water.

### Example 2.1

The product of Example 2 is diluted to a solids content of 10% by demineralized water. Using a coating blade (coating gap 50 μm), the solution is spread onto a polyester film. After 17 h of drying time at 20° C., a clear thin layer is obtained on the film which is no longer tacky. By increasing the temperature, the drying time can be significantly shortened.

The coated film is immersed for 2 h in demineralized water and subsequently examined optically. The layer has excellent adhesion even after the treatment with water.

### Example 3.1

The product of Example 3 is diluted to a solids content of 10% by demineralized water. Using a coating blade (coating gap 50 μm), the solution is spread onto a polyester film. After 17 h of drying time at 20° C., a clear thin layer is obtained on the film which is still only slightly tacky. By increasing the temperature, the drying time can be significantly shortened.

The coated film is immersed for 2 h in demineralized water and subsequently examined optically. The layer still in part adheres to the film even after the treatment with water.

### Biocidat Activity of the Inventive Silane-Modified Polymeric Amines

The silane-modified polyethyleneimines according to Examples 1 and 2 are tested with respect to their biocidal activity.

### Example 7

### Determination of the MIC Values of the Compound According to Example 1

The MIC (Minimum Inhibitory Concentration) values of the silane-modified polymeric amine according to Example 1, i.e. the lower concentration limit from which activity is observed, are determined with respect to their activity against fungi and bacteria. The activity is determined in each case by representative mixture of fungi (R. muciloginosa IMI 358541, G. candidum IMI 358544, C. albicans ATCC 10231, P. violacea IMI 14994811, P. pinohilum ATCC 9644, A. niger ATCC 16404, C. herbanum BOWATER 1030, F. solani IMI 314225, A. strictum IMI 321985, A. alternata IMI 358448, S. cerevisiae ATCC 9763) and also bacteria (P. fluorescens NCIMB 12201, E. coli NCIMB 8545, E aerogenes NCTC 10006, S. enteritica NCTC 74, P. aeruginosa NCIMB 10421, B. cepacia ATCC 17759, K. pneumoniae NCIMB 9111, P. pudita NCIMB 90347, A. faecalis DSM 13644, F. meningosepticum ATCC 13253, B. cereus ATCC 12826, C. freundii NCIMB 9750, S. aureus NCIMB 9518, A. baumanii ATCC 19606, B. subtilis ATCC 6633).

The MIC value for fungi is in a range from >1000 ppm to <10 000 ppm. The MIC value for bacteria is >10 000 ppm. This means that the compounds according to Example 1 exhibit an inhibitory activity against fungi from a concentration of >1000 ppm and an inhibitory activity against bacteria from a concentration of >10 000 ppm.

### Example 8

### Determination of Inhibition of Microbial Growth of Fungi of a Coating Formulation Which Comprises a Compound According to Example 1 and Example 2

A conventional coating formulation is mixed with 1% by weight of the silane-modified polymeric amine according to Example 1 or Example 2. The compounds added show no effect on the properties of the coating formulation. The coating formulation is applied to a wood substrate, a coated film being obtained. The fungal growth on the wood substrate is determined after one week. As a comparison, the fungal growth is determined on a wood substrate which has a dried film of the same coating formulation, but comprising no compounds according to Example 1 or 2.

The results are listed in the table hereinafter:

| | | Coating formulation | Coating formulation |
|---|---|---|---|
| | Control | 1 (1% by weight of | 2 (1% by weight of |
| | (no silane- | silane-modified | silane-modified |
| | modified | polymeric amine | polymeric amine |
| | polymeric | according to | according to |
| Fungus | amine) | Example 1) | Example 2) |
| A. niger | >80%¹⁾ | 30%¹⁾ | 30%¹⁾ |
| C. herbarum | >80%¹⁾ | 30%¹⁾ | 30%¹⁾ |
| P. pinohilum | >80%¹⁾ | 30%¹⁾ | 30%¹⁾ |

1) % of the surface which is visibly infected with fungi (degree of covering by fungi)

The test shows that the silane-modified polymeric amines according to Examples 1 and 2 have an inhibitory activity against the growth of fungi.

1-12. (canceled)

13. A silane-modified polymeric amine having a weight average molecular weight of 10,000 to 1,000,000 g/mol, the polymeric amine comprising at least one structural unit of the formula (I), wherein the polymeric amine has a main polymer chain, the at least one structural unit comprising a part of the main polymer chain or bound to the main polymer chain by an anchor group: 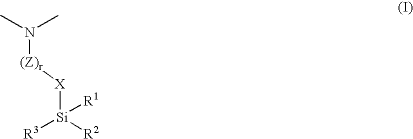
wherein X represents a bond or a —(CR⁴R⁵)ₙ— group; Z represents a moiety selected from the group consisting of —CONH—, —(CH₂)ₙ—O—, and —(CH₂)ₒ—CH(OH)—(CH₂)ₚ—(O)_{q}—; m represents a number 1 to 6; o represents a number 0 to 6; p represents a number 1 to 6; q represents a number 0 or 1; r represents a number 0 or 1; R¹, R², and R³ each independently represents a substituent selected from the group consisting of alkyls, OH, and O-alkyls; R⁴ and R⁵ each independently represents H or an alkyl; and n represents a number 1 to 20.

14. The silane-modified polymeric amine according to claim 13, wherein the at least one structural unit of formula (I) is part of the main polymer chain.

15. The silane-modified polymeric amine according to claim 13, wherein the at least one structural unit of formula (I) is bound to the main polymer chain by an anchor group.

16. The silane-modified polymeric amine according to claim 13, wherein X represents —(CH₂)ₙ—; n represents a number 1 to 6; Z represents —CH₂C(OH)CH₂O— or —C(OH)CH₂—; r represents a number 0 or 1; R¹, R², and R³ each independently represents OH or an —OC₁₋₆-alkyl.

17. The silane-modified polymeric amine according to claim 13, wherein X represents —(CH₂)ₙ—; n represents a number 1 to 3; r represents 0; R¹, R², and R³ each independently represents OCH₃ or OC₂H₅.

18. The silane-modified polymeric amine according to claim 13, wherein the main polymer chain comprises at least one polymer selected from the group consisting of polyalkylenepolyamines, vinylamine unit-comprising polymers, amine-epichlorohydrin polycondensates, polyaddition products of multifunctional epoxides and multifunctional amines, polyallylamines, condensates of lysine, condensates of ornithine and condensates of arginine.

19. The silane-modified polymeric amine according to claim 13, wherein the main polymer chain comprises at least one polymer selected from the group consisting of polyalkylenepolyamines, vinylamine unit-comprising polymers and condensates of lysine.

20. The silane-modified polymeric amine according to claim 13, wherein the main polymer chain comprises a polyalkylenepolyamine.

21. The silane-modified polymeric amine according to claim 13, wherein the main polymer chain comprises a polyethylenepolyamine.

22. The silane-modified polymeric amine according to claim 16, wherein the main polymer chain comprises at least one polymer selected from the group consisting of polyalkylenepolyamines, vinylamine unit-comprising polymers, amine-epichlorohydrin polycondensates, polyaddition products of multifunctional epoxides and multifunctional amines, polyallylamines, condensates of lysine, condensates of ornithine and condensates of arginine.

23. The silane-modified polymeric amine according to claim 16, wherein the main polymer chain comprises at least one polymer selected from the group consisting of polyalkylenepolyamines, vinylamine unit-comprising polymers and condensates of lysine.

24. The silane-modified polymeric amine according to claim 16, wherein the main polymer chain comprises a polyalkylenepolyamine.

25. The silane-modified polymeric amine according to claim 17, wherein the main polymer chain comprises at least one polymer selected from the group consisting of polyalkylenepolyamines, vinylamine unit-comprising polymers, amine-epichlorohydrin polycondensates, polyaddition products of multifunctional epoxides and multifunctional amines, polyallylamines, condensates of lysine, condensates of ornithine and condensates of arginine.

26. The silane-modified polymeric amine according to claim 17, wherein the main polymer chain comprises at least one polymer selected from the group consisting of polyalkylenepolyamines, vinylamine unit-comprising polymers and condensates of lysine.

27. A method for producing a silane-modified polymeric amine according to claim 13, the process comprising reacting a polymeric amine comprising at least one structural unit of the formula VIII: 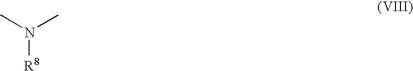
wherein the at least one structural unit of the formula VIII comprises a part of a main polymer chain, or can be bound to a main polymer chain by an anchor group, wherein R⁸ represents H or an alkyl,
with a silane of the formula IX: 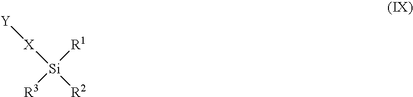
wherein X represents a bond or a —(CR⁴R⁵)ₙ— group; R¹, R², and R³ each independently represents a substituent selected from the group consisting of alkyls, OH, and O-alkyls; R⁴ and R⁵ each independently represents H or an alkyl; n represents a number 1 to 20; and Y represents a group reactive with the at least one structural unit of the formula VIII.

28. The method according to claim 27, wherein Y represents a moiety selected from the group consisting of halogens, epoxies, glycidoxyls, mercaptos, sulfidos, isocyanatos, cyanos, azidos and vinyls.

29. A silane-modified polymeric amine produced by the method according to claim 27.

30. A biocidally active formulation comprising at least one silane-modified polymeric amine according to claim 13.

31. The biocidally active formulation according to claim 30, further comprising at least one additional biocidally active compound.

32. The biocidally active formulation according to claim 30, further comprising a liquid selected from water, organic solvents and combinations thereof.
